(19) United States
(12) Patent Application Publication
(10) Pub. No.: US 2023/0069713 A1
(43) Pub. Date: Mar. 2, 2023

(54) MARKET SERVER AND POWER TRADING SYSTEM

(71) Applicant: TOYOTA JIDOSHA KABUSHIKI KAISHA, Toyota-shi (JP)

(72) Inventors: Kazutaka KIMURA, Mishima-shi (JP); Yuki KUDO, Susono-shi (JP); Kazuki OBATA, Susono-shi (JP); Hiromitsu KIGURE, Ashigarakami-gun (JP); Yuta MANIWA, Susono-shi (JP); Satoshi KIKUCHI, Hadano-shi (JP)

(73) Assignee: TOYOTA JIDOSHA KABUSHIKI KAISHA, Toyota-shi (JP)

(21) Appl. No.: 17/821,583

(22) Filed: Aug. 23, 2022

(30) Foreign Application Priority Data
Aug. 26, 2021 (JP) 2021-137932
Aug. 26, 2021 (JP) 2021137932

(51) Int. Cl. G06Q 40/04

(52) U.S. Cl. CPC G06Q 40/04

(57) ABSTRACT

A market server stores participant information of each of participants in a power trading market, the participant information includes a participant ID that specifies the participant and participant evaluation information associated with the participant ID and set based on a trading history of the participant, and when the participant evaluation information satisfies a predetermined condition, the market server permits the participant specified by the participant ID associated with the participant evaluation information to participate in the power trading market.

This nonprovisional application is based on Japanese Patent Application No. 2021-137932 filed on Aug. 26, 2021, with the Japan Patent Office, the entire contents of which are hereby incorporated by reference.

### BACKGROUND

### Field

The present disclosure relates to a market server and a power trading system.

### Description of the Background Art

Japanese Patent Laying-Open No. 2020-9334 discloses a power trading system. In this power trading system, power trading is performed between a power seller as a participant and a power buyer as a participant.

### SUMMARY

In the technology described in Japanese Patent Laying-Open No. 2020-9334, a malicious participant may participate in the power trading market. For example, a power buyer as a malicious participant may buy up power by buying the power at a high price. In this case, a confusion or the like may be caused in the power trading market. Thus, in the conventional power trading system, the power trading market can be provided without guaranteeing reliability of a participant, disadvantageously.

The present disclosure has been made to solve the above-described problem, and has an object to provide a power trading market in which reliability of a participant is guaranteed.

A market server according to the present disclosure includes: a memory that stores participant information of each of participants in a power trading market, and a processor. The participant information includes a participant ID that specifies the participant, and participant evaluation information associated with the participant ID and set based on a trading history of the participant. When the participant evaluation information satisfies a predetermined condition, the processor permits the participant specified by the participant ID associated with the participant evaluation information to participate in the power trading market.

According to such a configuration, when the participant evaluation information satisfies the predetermined condition, the participant specified by the participant ID associated with the participant evaluation information is permitted to participate in the power trading market, thereby providing a power trading market in which reliability of the participant is guaranteed.

The participant evaluation information may be an evaluation point. The participant evaluation information may satisfy the predetermined condition when the evaluation point is more than or equal to a first threshold value.

According to such a configuration, when the evaluation point is more than or equal to the first threshold, the participant specified by the participant ID associated with the evaluation point is permitted to participate in the power trading market, thereby providing a power trading market in which reliability of the participant is guaranteed.

The processor may increase or decrease the evaluation point based on the trading history of the participant specified by the participant ID associated with the evaluation point.

According to such a configuration, the participant can be promoted to perform power trading in the power trading market.

The trading history of the participant may include at least one of a power trading amount of power traded by the participant and a power trading time of the power traded by the participant.

According to such a configuration, the participant can be promoted to increase at least one of the power trading amount and the power trading time.

Further, power traded in the power trading market may include first power involving a first amount of carbon dioxide to be discharged to generate a unit amount of power, and second power involving a second amount of carbon dioxide to be discharged to generate the unit amount of power, the second amount being less than the first amount. The trading history of the participant may include at least one of a ratio of the second power in power traded by the participant, and a power trading price of the power traded by the participant.

According to such a configuration, the participant can be promoted to increase at least one of the ratio of the second power in the traded power and the power trading price.

Further, the processor may obtain the participant ID and trading data about power trading, and when a content of the trading data satisfies an appropriateness condition, the processor may increase the evaluation point associated with the participant ID. When the content of the trading data does not satisfy the appropriateness condition, the processor may decrease the evaluation point associated with the participant ID.

According to such a configuration, the participant can be promoted to cause the content of the trading data to satisfy the appropriateness condition.

Further, the appropriateness condition may include a condition that a power trading price included in the trading data falls within a first normal range.

According to such a configuration, the participant can be promoted to cause the power trading price to fall within the first normal range.

Further, the appropriateness condition may include a condition that a power trading amount included in the trading data falls within a second normal range.

According to such a configuration, the participant can be promoted to cause the power trading price to fall within the second normal range.

Further, the trading data may include generation information indicating a method of generating power to be sold. Moreover, the appropriateness condition may include a condition that the market server obtains information indicating that the generation information is accurate.

According to such a configuration, the participant can be promoted to accurately indicate the method of generating power to be supplied.

The trading data may include a power trading time period and a power trading amount. Further, the appropriateness condition may include a condition that power corresponding to the power trading amount has been traded by the participant during the power trading time period.

According to such a configuration, the participant can be promoted to perform power trading corresponding to the intended power trading amount in the intended power trading time period.

Further, the processor may output an evaluation point of a participant who makes a bid for a request condition, to at least one of an agent device used by a participant who has presented the request condition and an agent device used by the participant who makes the bid.

According to such a configuration, the evaluation point of the participant who makes the bid for the request condition can be recognized by at least one of the participant who has presented the request condition and the participant who makes the bid for the request condition.

Further, the processor may update the participant information to provide the participant with a larger benefit as the evaluation point is higher.

According to such a configuration, the participant is promoted to increase the evaluation point.

Further, the larger benefit may include an increase in power trading amount. According to such a configuration, the power trading amount for the participant having the increased evaluation point is increased, thereby realizing power trading advantageous to the participant.

Further, the larger benefit may include an increase in power trading data accessible by an agent device used by the participant.

According to such a configuration, the number of visually recognizable screens based on the data about the power trading is increased for the participant having the increased evaluation point, thereby realizing power trading advantageous to the participant.

Further, the larger benefit may include an increase in degree of precedence for making an agreement on the power trading.

According to such a configuration, the degree of precedence for making an agreement is increased for the participant having the increased evaluation point, thereby realizing power trading advantageous to the participant.

Further, power traded in the power trading market may include first power involving a first amount of carbon dioxide to be discharged to generate a unit amount of power, and second power involving a second amount of carbon dioxide to be discharged to generate the unit amount of power, the second amount being less than the first amount. Moreover, the larger benefit may include an increase in trading amount of the second power.

According to such a configuration, the power trading amount for the participant having an increased evaluation point is increased, thereby realizing power trading advantageous to the participant.

Further, the market server may transmit, to an agent device used by the participant, an encryption key corresponding to the evaluation point associated with the participant ID. Moreover, the agent device may generate encryption data by encrypting, using the encryption key, trading data about participation in the power trading market, and may transmit the participant ID and the encryption data to the market server. The market server may obtain the trading data, the participant ID, and the evaluation point by decrypting the encryption data using a decryption key corresponding to the encryption key, and when the evaluation point associated with the obtained participant ID coincides with the obtained evaluation point, the market server may determine that the encryption key is not falsified.

According to such a configuration the evaluation point for evaluating the participant can be used to determine that the encryption data is not falsified. Therefore, the volume of data to be used can be reduced as compared with a market server in which data for evaluating a participant and data for determining that encryption data is not falsified are different.

Further, a power trading system of the present disclosure includes: a market server of a power trading market and an agent device used by each of participants of the power trading market. The market server has a memory that stores participant information of the participant. The participant information includes a participant ID that specifies the participant, and participant evaluation information associated with the participant ID and set based on a trading history of the participant. When the participant evaluation information satisfies a predetermined condition, the market server permits the participant specified by the participant ID associated with the participant evaluation information to participate in the power trading market.

According to such a configuration, when the participant evaluation information satisfies the predetermined condition, the participant specified by the participant ID associated with the participant evaluation information is permitted to participate in the power trading market, thereby providing a power trading market in which reliability of the participant is guaranteed.

The foregoing and other objects, features, aspects and advantages of the present invention will become more apparent from the following detailed description of the present invention when taken in conjunction with the accompanying drawings.

### BRIEF DESCRIPTION OF THE. DRAWINGS

FIG. 1 is a diagram showing participation in the present embodiment.

FIG. 2 is a diagram showing an exemplary configuration of a power trading system according to the present embodiment.

FIG. 3 is a diagram showing the exemplary configuration of the power trading system according to the present embodiment.

FIG. 4 is a diagram showing hardware configurations of an agent device and a market server.

FIG. 5 is a diagram showing an exemplary input screen.

FIG. 6 is a diagram showing an exemplary agent database.

FIG. 7 is a diagram showing an exemplary participant database.

FIG. 8 is a functional block diagram of an agent device and a market server.

FIG. 9 is a diagram showing an exemplary relation between an evaluation point and a threshold value.

FIG. 10 is a diagram showing an exemplary increase/decrease in evaluation point when a first update condition is satisfied.

FIG. 11 is a diagram showing exemplary appropriateness conditions.

FIG. 12 is a diagram showing exemplary benefits in the present embodiment.

FIG. 13 is a diagram showing an exemplary power trading screen.

FIG. 14 is a diagram showing an example of displaying of evaluation points.

FIG. 15 is a flowchart of starting power trading.

FIG. 16 is a flowchart of ending the power trading.

### DESCRIPTION OF THE PREFERRED EMBODIMENTS

Hereinafter, embodiments of the present disclosure will be described in detail with reference to figures. In the figures, the same or corresponding portions are denoted by the same reference characters, and will not be described repeatedly.

### First Embodiment

### Power Trading Market

In the present embodiment, a power trading market in which so-called P2P (Peer to Peer) power trading is employed is disclosed. Those who participate in the power trading market will be referred to as “participants”. The participants include: a presenter who presents a request condition; and a bidder who makes a bid for the request condition. The presenter includes a power seller and a power buyer. When the presenter is the power seller, the bidder is the power buyer. On the other hand, when the presenter is the power buyer, the bidder is the power seller. In the present embodiment, the term “participation” includes both “presentation of a request condition” and “bidding for a request condition”. Further, the term “power trading” includes both buying of power and selling of power.

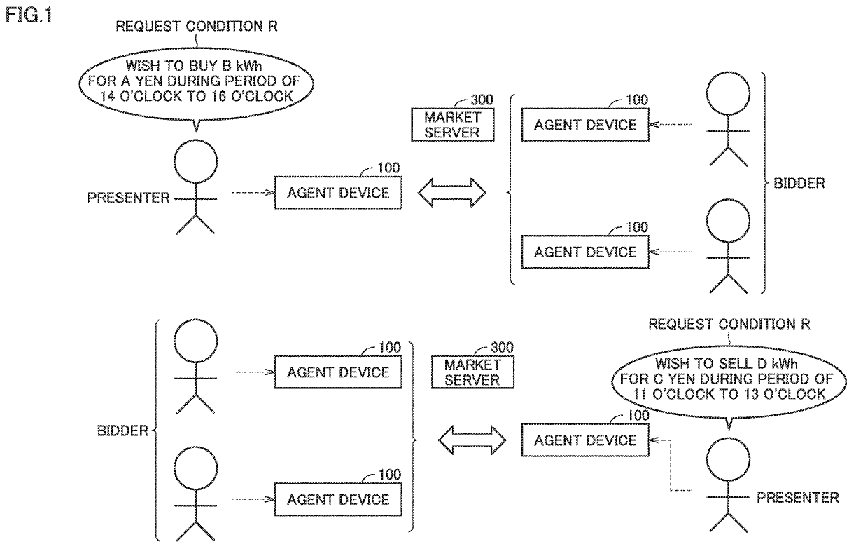

FIG. 1 is a diagram showing participants. Each of the participants has an agent device 100 used by the participant. In the upper part of FIG. 1, it is illustratively shown that the presenter is a power buyer and the bidders are power sellers. The presenter inputs, to agent device 100 with which the presenter has logged into the account of the presenter, a request condition R via an input screen (see FIG. 5) of agent device 100. Request condition R includes a power trading time period, a power trading price, and a power trading amount.

The power trading time period is a time period during which the presenter (power buyer) desires to buy power. The power trading price is a price of power at which the presenter (power buyer) desires to buy. The power trading amount is an amount of power bought by the presenter (power buyer). In the example of FIG. 1, the power trading time period ranges from 14 o'clock to 16 o'clock, the power trading price is A yen, and the power trading amount is B kWh.

When the request condition is obtained, a below-described market server 300 notifies opening of trading to each of agent devices 100 at a time preceding by a predetermined time from the starting time specified in the power trading time period. For example, when the starting time is 15 o'clock, the opening of trading is notified at 14 o'clock, which is one hour (predetermined time) before the starting time.

Each of one or more bidders (power buyers) having agent device(s) 100 each having received the notification of the opening of trading inputs a bidding condition via the input screen (see FIG. 5) to agent device 100 (agent device having received the notification of the opening of trading) with which the bidder has logged into the account of the bidder. The bidding condition includes a power trading time period, a power trading price, and a power trading amount.

The power trading time period is a time period during which a bidder (power seller) desires to sell power. The power trading price is a price of power at which the bidder (power seller) desires to sell. The power trading amount is an amount of power sold by the bidder (power seller).

In the lower part of FIG. 1, it is illustratively shown that the presenter is a power seller and the bidders are power buyers. The presenter inputs, to agent device 100 with which the presenter has logged into the account of the presenter, a request condition R via the input screen (see FIG. 5). The request condition includes a power trading time period, a power trading price, and a power trading amount.

The power trading time period is a time period during which the presenter (power seller) desires to sell power. The power trading price is a price of power at which the presenter (power seller) desires to sell. The power trading amount is an amount of power sold by the presenter (power seller). In the example of FIG. 1, the power trading time period ranges from 11 o'clock to 13 o'clock, the power trading price is C yen, and the power trading amount is D kWh.

When the market server obtains the request condition, the market server notifies opening of trading to each of agent devices 100 at a time preceding by a predetermined time from the starting time specified in the power trading time period. For example, when the starting time is 15 o'clock, the opening of trading is notified at 14 o'clock, which is one hour (predetermined time) before the starting time.

Each of one or more bidders (power buyers) having agent device(s) 100 each having received the notification of the opening of trading inputs a bidding condition via the input screen (see FIG. 5) to agent device 100 (agent device having received the notification of the opening of trading) with which the bidder has logged into the account of the bidder. The bidding condition includes a power trading time period, a power trading price, and a power trading amount.

The power trading time period is a time period during which a bidder (power buyer) desires to buy power. The power trading price is a price of power at which the bidder (power buyer) desires to buy. The power trading amount is an amount of power bought by the bidder (power buyer).

When below-described market server 300 determines that the request condition and the bidding condition match with each other, an agreement on the power trading is made. The expression “the request condition and the bidding condition match with each other” means, for example, that the power trading time period of the bidding condition falls within the range of the power trading time period of the request condition, the power trading amount of the bidding condition coincides or substantially coincides with the power trading amount of the request condition, and the power trading price of the bidding condition coincides or substantially coincides with the power trading price of the request condition. In the case where the agreement on the power trading is made, the presenter and the bidder then perform the power trading (exchange of power) during the power trading time period included in the bidding condition. On the other hand, when market server 300 determines that the request condition and the bidding condition do not match with each other, no agreement on the power trading is made.

The agent device used by the presenter who presents the request condition (i.e., the agent device to which the request condition is input) will be also referred to as “first agent device”. The agent device used by the bidder who presents the bidding condition (i.e., the agent device to which the bidding condition is input) will be also referred to as “second agent device”.

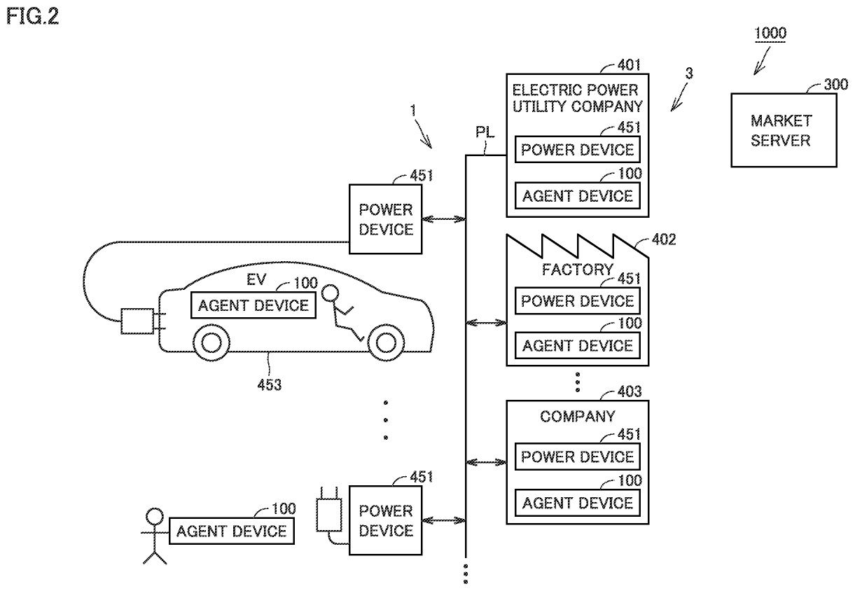

FIG. 2 shows an exemplary configuration of a power trading system 1000 according to the present embodiment. In the example of FIG. 2, power trading system 1000 includes agent devices 100, market server 300, power devices 451, and the like.

Each of power devices 451 can generate and output (discharge) power. Moreover, power device 451 can receive (can be charged with) input power from outside. In the example of FIG. 2, it is illustratively shown that power devices 451 are disposed in an electric power utility company 401, a factory 402, and a company 403.

Each of power devices 451 can charge, for example, a device (hereinafter, also referred to as “power-operated device”) operated by consuming power. The power-operated device is, for example, a movable body 453. Movable body 453 is typically an electrically powered vehicle having a battery mounted thereon for the purpose of traveling, such as a battery electric vehicle (BEV), a hybrid electric vehicle (HEV), or a plug-in hybrid electric vehicle (PHEV). In the example of FIG. 2, power device 451 exchanges power with another power device 451 via a power transmission line PL.

As shown in FIG. 2, agent device 100 may be included in an onboard device of movable body 453. Alternatively, agent device 100 may be included in power device 451. Agent device 100 may be constituted of a personal computer (PC), a tablet, a smartphone, or the like. In the example shown in FIG. 2, it is illustratively shown that agent device 100 is mounted on movable body 453 as an onboard device of movable body 453. Moreover, in the example of FIG. 2, it is illustratively shown that agent device 100 is a smartphone owned by a human being. Further, in the example of FIG. 2, it is illustratively shown that agent device 100 is a PC disposed in each of electric power utility company 401, factory 402, and company 403.

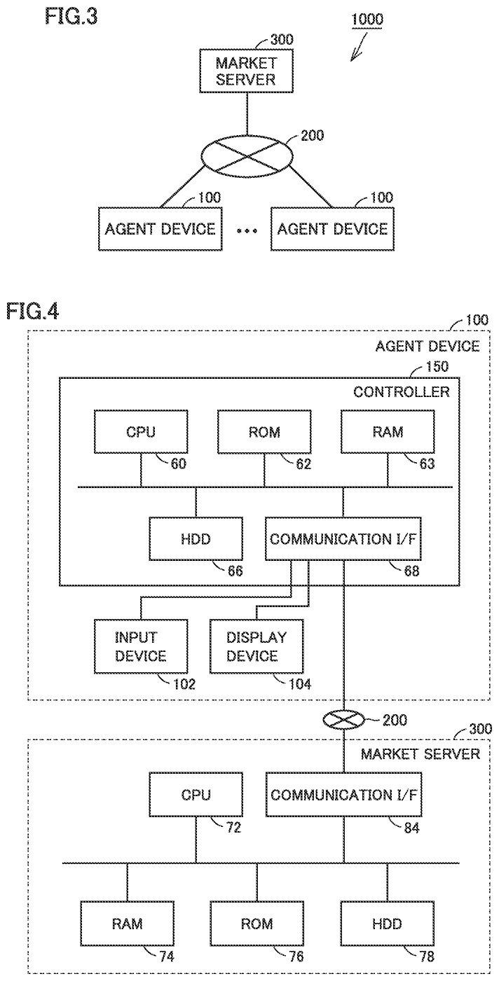

FIG. 3 is a diagram showing power trading system 1000 from a viewpoint different from that of FIG. 2. In the example of FIG. 3, power trading system 1000 includes market server 300, the plurality of agent devices 100, and a network 200. Each agent device 100 and market server 300 can communicate with each other via network 200.

### Hardware Configurations

FIG. 4 is a diagram showing hardware configurations of agent device 100 and market server 300. Agent device 100 includes a controller 150, an input device 102, and a display device 104. Controller 150 includes a CPU (Central Processing Unit) 60, a storage unit that stores a program and data, and a communication (interface) 68. The components are connected to one another via a data bus. When agent device 100 is included in an onboard device, CPU 60 may be replaced with an ECU (Electronic Control Unit).

The storage unit includes a ROM (Read Only Memory) 62, a RAM (Random Access Memory) 64, and an HDD (Hard Disk Drive) 66, ROM 62 can store a program to be executed by CPU 60. RAM 63 can temporarily store data generated by executing a program by CPU 60 and data input via communication I/F 68, and can function as a temporary data memory used as a work area. HDD 66 is a non-volatile storage device and can store various information. Alternatively, a semiconductor storage device such as a flash memory may be employed instead of HDD 66.

Communication I/F 68 is an interface for communicating with market server 300 via network 200. Communication I/F 68 can communicate with input device 102 and display device 104.

Input device 102 is a pointing device such as a keyboard or a mouse, and receives an operation by a user. Display device 104 is constituted of, for example, a liquid crystal display (LCD) panel, and displays information to the user. When a touch panel is used as the user interface, input device 102 and display device 104 are formed in one piece.

Market server 300 includes a CPU 72, a storage unit (ROM 76, RAM 74, and HDD 78), and a communication I/F 84.

ROM 76 can store a program to he executed by CPU 72. RAM 74 can function as a data memory that can temporarily store data generated by executing a program by CPU 72, data from agent device 100, and the like. HDD 78 is a non-volatile storage device, and can store information generated by market server 300. Alternatively, a semiconductor storage device such as a flash memory may be employed instead of HDD 78. Communication I/F 84 is an interface for communicating with agent device 100 via network 200.

### Input Screed

FIG. 5 shows an exemplary input screen 350 displayed in a display region 104A of display device 104 of agent device 100. In agent device 100, the participant inputs a request condition or a bidding condition to input screen 350 using input device 102. For example, input screen 350 in a state in which no notification of opening of trading is received is input screen 350 in which the presenter inputs a request condition. On the other hand, input screen 350 in a state in which a notification of opening of trading is received is input screen 350 in which the bidder inputs a bidding condition.

In input screen 350, a text image 351 “MARKET PARTICIPATION SCREEN” is displayed. In input screen 350, an input item 352 “TRADING TYPE” is displayed. An option 354 to buy power and an option 356 to sell power are displayed as options of the trading type. In the present embodiment, the options are displayed in the form of checkboxes.

When a checkmark is added in option 354 “BUY POWER”, the participant can participate in the power trading market as a power buyer. When a checkmark is added in option 356 “SELL POWER”, the participant can participate in the power trading market as a power seller.

In input screen 350, an input item 358 “POWER TYPE” is displayed. As options for the power type, an option 360 for renewable energy power and an option 362 for ordinary power are displayed.

Here, the renewable energy power and the ordinary power will be described. The power traded in power trading system 1000 includes first power and second power. The first power is power involving a first amount of carbon dioxide to be discharged to generate a unit amount of power. The unit amount is a predetermined amount. On the other hand, the second power is power involving a second amount of carbon dioxide to be discharged to generate the unit amount of power, the second amount being less than the first amount. That is, the amount of carbon dioxide to be discharged to generate the second power is less than the amount of carbon dioxide to be discharged to generate the first power.

The first power is, for example, power generated using depletable energy. Examples of the depletable energy include petroleum, natural gas, oil sand, methane hydrate, and uranium.

The second power is, for example, power generated using renewable energy. Examples of the renewable energy include energy such as wind power, solar light, hydraulic power, and biomass. Therefore, in view of global environmental protection, it is preferable to trade the second power rather than the first power. In the present embodiment, the renewable energy power is an example of the second power, and the ordinary power is an example of the first power.

When a checkmark is added in option 360 “RENEWABLE ENERGY POWER”, the participant can participate in the power trading market as a power buyer or power seller of the renewable energy. On the other hand, when a checkmark is added in option 362 “ORDINARY POWER”, the participant can participate in the power trading market as a power buyer or power seller of the ordinary power.

Further, in input screen 350, an input item 364 “POWER TRADING AMOUNT” is displayed. An input region 366 for the power trading amount is displayed in association with input item 364. The participant can input a numerical value of the power trading amount into input region 366. The participant can participate in the power trading market as a power buyer or power seller for the power trading amount input in input region 366.

Further, in input screen 350, an input item 368 “TRADING TIME PERIOD” is displayed. An input region 370 for the starting time of the trading time period and an input region 372 for the ending time of the trading time period are displayed in association with input item 368. The participant can input the starting time of the power trading into input region 370 and can input the ending time of the power trading into input region 372. The participant can participate in the power trading market as a power buyer or power seller in the trading time period input in input region 370.

Further, in input screen 350, an input item 374 “POWER PRICE” is displayed. An input region 376 for the power price is displayed in association with input item 374. The participant can input a numerical value of the power price into input region 376. The participant can participate in the power trading market as a power buyer or power seller for the power price input in input region 376.

Further, in input screen 350, a participation starting button 378 is displayed. After the participant inputs the trading type, the power type, the power trading amount, the power trading time period, and the power price, the participant can operate participation starting button 378. When participation starting button 378 is operated by the participant, the participant participates in the power trading market.

### Database

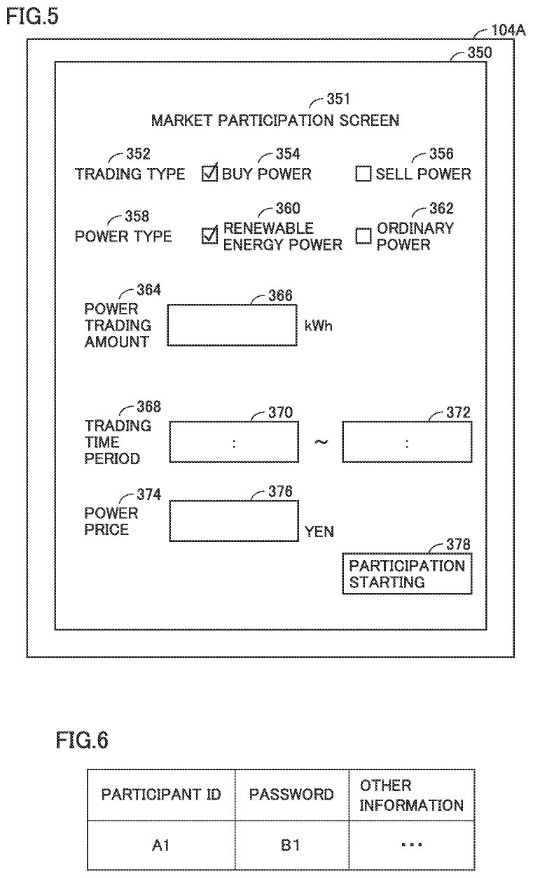

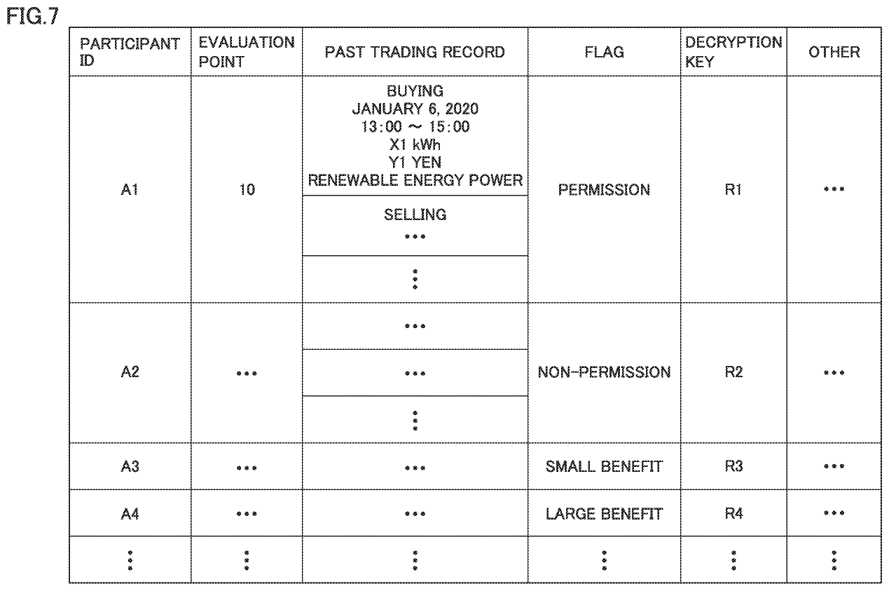

Next, a database used in power trading system 1000 of the present embodiment will be described. FIG. 6 is a diagram showing an exemplary agent database. The agent database is a database held by agent device 100. In the example of FIG. 6, a participant ID, a password, and other information are stored. In the present embodiment, a participant who participates in power trading system 1000 for the first time newly makes a request for participation to market server 300. In newly making a request for participation, the participant inputs the name, address, and the like of the participant in a new registration screen (not shown). When the name, address, or the like of the participant is input by the participant who participates for the first time, the market server provides an account to the participant. The account includes a participant ID and a password associated with the participant ID. As shown in FIG. 7, a processing unit 108 stores the participant ID provided by market server 300, the password provided by market server 300, and the other information (for example, the vehicle type of a vehicle owned by the participant).

FIG. 7 shows an exemplary participant database. The participant database is a database held by market server 300. The participant database is managed by a block chain technique, for example. In the example of FIG. 7, an evaluation point, a past trading record, a flag, a decryption key, and other information are associated with a participant ID. The “evaluation point” is exemplary participant evaluation information (index) used to evaluate the participant. The evaluation point will be described later.

The “past trading record” indicates a past trading record of the participant specified by the participant ID in power trading system 1000. The past trading record includes a past power buying record and a past power selling record. The past trading record is a history of trading that is based on an agreed bid.

The “flag” includes a permission flag, a non-permission flag, a small-benefit flag, and a large-benefit flag. The permission flag is a flag indicating that participation in power trading system 1000 is permitted. The non-permission flag is a flag indicating that participation in power trading system 1000 is not permitted. The small-benefit flag is a flag indicating that participation in power trading system 1000 is permitted and a below-described small benefit is provided. The large-benefit flag is a flag indicating that participation in power trading system 1000 is permitted and a below-described large benefit is provided.

Next, the “decryption key” will be described. As described below, market server 300 generates, for each participant ID, an encryption key corresponding to the point corresponding to the participant ID. The decryption key is a key for decrypting encryption data generated by the encryption key. Examples of the other information include personal information (such as name and address) of the participant specified from the participant ID.

In the example of FIG. 7, an evaluation point associated with a participant ID A1 is 10 points. A past trading record associated with participant ID A1 includes a record indicating that X1 kWh of renewable energy power was bought for Y1 yen during a time period of 13 o'clock to 15 o'clock on Jan. 6, 2020, and the like. A flag associated with participant ID A1 is a permission flag. A decryption key associated with participant ID A1 is a decryption key R1. It should be noted that each of three-dot leaders in the example of FIG. 7 indicates that data is actually stored but the description thereof is omitted.

Further, information other than the participant ID in the information defined in the participant database corresponds to “participant information” of the present disclosure.

### Functional Block Diagram

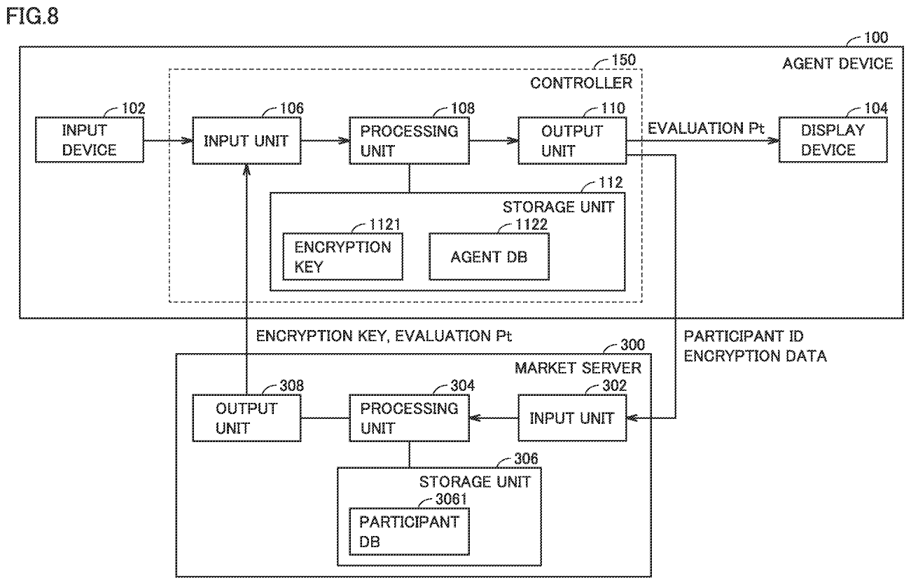

FIG. 8 is a functional block diagram of agent device 100 and market server 300. In the example of FIG. 8, controller 150 has an input unit 106, a processing unit 108, an output unit 110, and a storage unit 112. Storage unit 112 mainly stores an encryption key 1121 and an agent database. Agent database 1122 is the database of FIG. 6. The encryption key is stored in association with the participant ID. It should be noted that in FIG. 8, the database is described as DB (database).

Market server 300 has an input unit 302, a processing unit 304, a storage unit 306, and an output unit 308. Storage unit 306 mainly stores a participant database 3061. Participant database 3061 is the database of FIG. 7. Storage unit 306 corresponds to “memory” of the present disclosure. Input unit 302, processing unit 304, and output unit 308 correspond to “processor” of the present disclosure.

For each participant ID, processing unit 304 of market server 300 generates, at a predetermined timing, an encryption key associated with an evaluation point associated with the participant ID, and a decryption key corresponding to the encryption key. The predetermined timing is a timing at which the evaluation point is updated. The predetermined timing will be described later. Processing unit 108 stores the decryption key into the participant database in association with the participant ID (see the description of FIG. 7). It should be noted that in FIG. 8, the evaluation point is indicated as “EVALUATION Pt”.

Further, processing unit 304 transmits, via output unit 308, the encryption keys corresponding to all the participant IDs to agent devices 100 corresponding to all the participant IDs. Each of the encryption key is input to input unit 106 of corresponding agent device 100. The encryption key is output to processing unit 108. Processing unit 108 stores the encryption key into storage unit 112 (see encryption key 1120. Thus, encryption key 1121 is stored in storage unit 112 in advance.

Further, input screen 350 of FIG. 5 is displayed on display device 104. Hereinafter, the request condition input to input screen 350 and the bidding condition input to input screen 350 are also collectively referred to as “input condition”. The participant inputs an input condition to input screen 350 using input device 102. The input condition is input to input unit 106 of controller 150. The input condition input to input unit 106 is output to processing unit 108.

Processing unit 108 processes the input condition as trading data about participation in the power trading market. In the present embodiment, the trading data is data indicating the trading type, the power type, the power trading amount, the trading time period, and the power price as shown in FIG. 5.

Processing unit 108 generates encryption data by encrypting the trading data using encryption key 1121. Here, the encryption data is generated to include the evaluation point corresponding to encryption key 1121. Then, processing unit 108 transmits the encryption data and the participant ID stored in the agent database to market server 300 via output unit 110.

The participant ID and the encryption data are input to input unit 302 of market server 300. The input participant ID and the encryption data are output to processing unit 304. Processing unit 304 makes reference to the participant database so as to decrypt the encryption data using the decryption key corresponding to the participant ID (i.e., the decryption key corresponding to the encryption key). As described above, the encryption data includes the evaluation point corresponding to the encryption key for generating the encryption data. Accordingly, processing unit 304 decrypts the encryption data to obtain the trading data, the participant ID, and the evaluation point. Then, processing unit 304 extracts, from the participant database (see FIG. 7), the evaluation point associated with the obtained participant ID. Then, processing unit 304 compares the evaluation point (hereinafter, also referred to as “first evaluation point”) obtained from controller 150 with the evaluation point (hereinafter, also referred to as “second evaluation point”) extracted from the participant database.

Here, when the evaluation point described later is high, various benefits are provided to the participant. Therefore, a malicious person (for example, the owner of agent device 100) may falsify the encryption key or the like so as to increase the evaluation point. When the encryption key is falsified, the first evaluation point and the second evaluation point are different from each other. Therefore, when processing unit 304 determines that the first evaluation point and the second evaluation point are different from each other, processing unit 304 determines that the encryption key is falsified. When it is determined that the encryption key is falsified, market server 300 transmits, to agent device 100, a notification indicating that the encryption key is falsified. On the other hand, when processing unit 304 determines that the first evaluation point and the second evaluation point coincide with each other, processing unit 304 determines that the encryption key is not falsified.

Market server 300 can notify, to agent device 100, the evaluation point corresponding to the participant ID stored in agent device 100. Agent device 100 can display the evaluation point on display device 104. The displaying of the evaluation point will be described later with reference to FIG. 14.

In the present embodiment, it has been described that agent device 100 is configured to process, as trading data, the input condition input to the input screen by the participant. However, agent device 100 may be configured to generate the trading data based on an SOC (State Of Charge) or the like of the power-operated device associated with agent device 100.

### Evaluation Point

Next, the evaluation point will be described. As described above, the evaluation point is exemplary participant evaluation information used to evaluate the participant. The evaluation point is set (updated) based on the trading history of the participant. In the present embodiment, market server 300 updates the evaluation point when a first update condition or a second update condition is satisfied. Further, market server 300 increases the evaluation point when desirable trading is performed on power trading system 1000, and decreases the evaluation point when undesirable trading is performed on power trading system 1000.

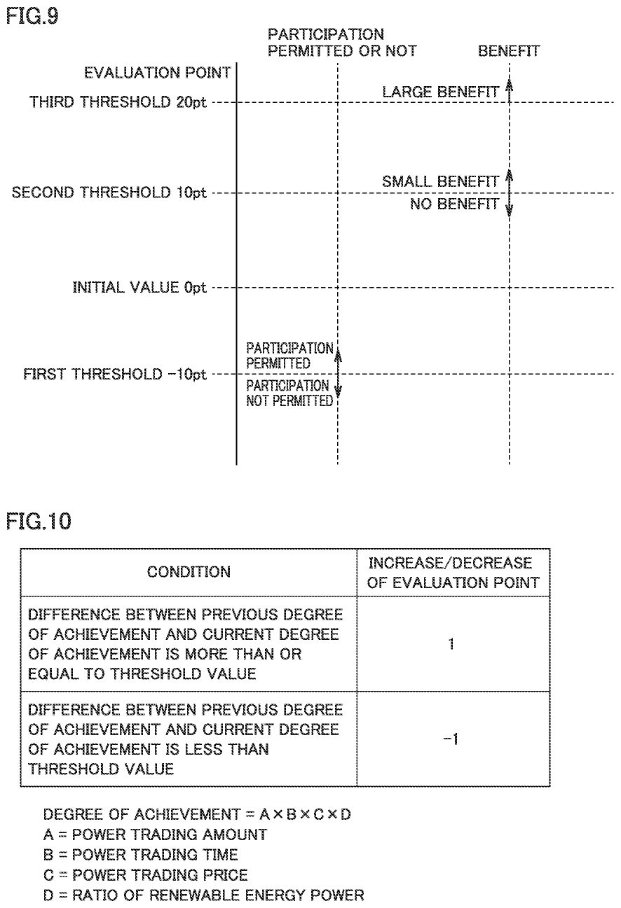

FIG. 9 is a diagram showing an exemplary relation between the evaluation point and a threshold value. As shown in FIG. 9, the initial value of the evaluation point is 0 point. For example, the evaluation point of a participant who participates in power trading system 1000 for the first time is the initial value (0 point).

Further, the first threshold is −10 points. When the evaluation point is more than or equal to the first threshold (−10 points), market server 300 permits the participant specified by the participant ID associated with the evaluation point to participate in the power trading market (power trading system 1000). A process of permitting the participant to participate in the power trading market (power trading system 1000) is typically a process of associating a permission flag with the participant 11 of the participant (see the column “FLAG” in FIG. 7). The expression “the evaluation point is more than or equal to the first threshold value” corresponds to the expression “the predetermined condition is satisfied” in the present disclosure.

When the evaluation point is less than the first threshold, market server 300 prohibits the participant specified by the participant ID associated with the evaluation point from participating in the power trading market. The process of prohibiting the participant from participating in the power trading market is typically a process of associating a non-permission flag with the participant ID of the participant (see the column “FLAG” in FIG. 7).

The second threshold value is 10 points. When the evaluation point is more than or equal to the second threshold value (10 points), market server 300 provides a below-described small benefit to the participant corresponding to the evaluation point. A process of providing a small benefit to the participant is typically a process of associating a small-benefit flag with the participant ID of the participant (see the column “FLAG” in FIG. 7). In other words, the process of providing the small benefit to the participant is typically a process of updating the participant information to provide the small benefit.

The third threshold is 20 points. When the evaluation point is more than or equal to the third threshold value (20 points), market server 300 provides a below-described large benefit to the participant corresponding to the evaluation point. Typically, a process of providing a large benefit to the participant is a process of associating a large-benefit flag with the participant ID of the participant (see the column “FLAG” in FIG. 7). In other words, the process of providing the large benefit to the participant is typically a process of updating the participant information to provide the large benefit.

Next, the updating of the evaluation point will be described. First, the first update condition will be described. The first update condition is, for example, a condition that a predetermined period has elapsed. The predetermined period may be any period. For example, the predetermined period may be one week or one month. In the present embodiment, the predetermined period is one month. When the first update condition is satisfied, market server 300 increases or decreases the evaluation point based on the trading history of the participant specified by the participant ID associated with the evaluation point.

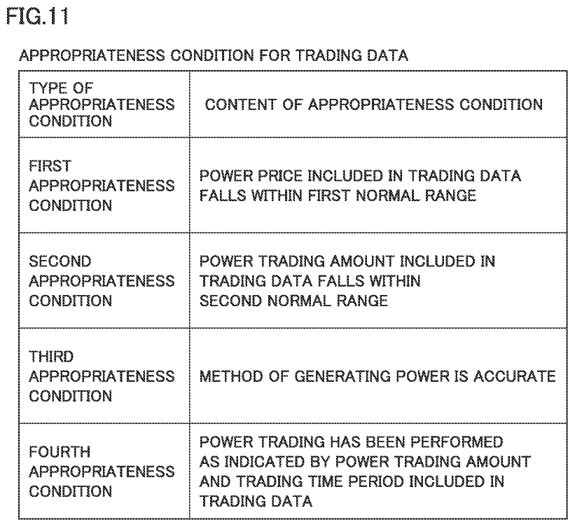

FIG. 10 is a diagram showing an exemplary increase/decrease in evaluation point when the first update condition is satisfied. Market server 300 increases or decreases the evaluation point based on the trading history of the participant. In the present embodiment, market server 300 increases or decreases the evaluation point based on a degree of achievement calculated from the trading history of the participant. The degree of achievement is an index indicating a degree of involvement in the power trading of power trading system 1000. In the example of FIG. 10, market server 300 calculates the degree of achievement in accordance with the following formula (1):

Degree of achievement=A×B×C×D (1).

In the example of the formula (1), market server 300 calculates the degree of achievement by multiplying a real number A, a real number B, a real number C, and a real number D.

Real number A on the right side of the formula (1) is the total amount of power trading amounts of power traded by the participant in the past. Real number B on the right side of the formula (1) is the total amount of power trading times of the power traded by the participant in the past. Real number C on the right side of the formula (1) is the total amount of power prices of the power traded by the participant in the past. Real number D on the right side of the formula (1) is the total amount of ratios of renewable energy power traded by the participant in the past. The ratio of renewable energy power is calculated by, for example, the following formula (2):

The ratio of the renewable energy power=the total amount of the renewable energy power traded in the past/the total amount of the whole of the power traded in the past (2).

In the example of the formula (2), market server 300 calculates the ratio (real number D) of the renewable energy power by dividing the “total amount of the renewable energy power traded in the past” by the “total amount of the whole of the power traded in the past”. The total amount of the whole of the power traded in the past is the total amount of the ordinary power and the renewable energy power.

Market server 300 can obtain real numbers A to D from the past trading history of the participant database (see FIG. 7), for example.

It should be noted that as a modification, market server 300 may calculate the degree of achievement using one to three real numbers of real number A, real number B, real number C, and real number D. Further, market server 300 may calculate the degree of achievement using the total of at least two of real numbers A to D.

Further, as shown in FIG. 10, market server 300 calculates a difference between a previous degree of achievement (i.e., a degree of achievement one month ago) and a current degree of achievement (i.e., a degree of achievement at the current time). Specifically, market server 300 calculates the difference by subtracting the previous degree of achievement from the current degree of achievement. When the difference is more than or equal to a predetermined threshold, market server 300 increases the evaluation point by a predetermined amount (one point in the present embodiment). On the other hand, when the difference is less than the threshold, market server 300 decreases the evaluation point by a specific amount (one point in the present embodiment). Here, the threshold value is a predetermined value, and may be changed by, for example, an administrator or the like of market server 300.

The difference that is more than or equal to the threshold value means that the participant has performed power trading many times during a period (i.e., one month) of time from the calculation of the previous degree of achievement to the calculation of the current degree of achievement. Therefore, market server 300 increases the evaluation point of such a participant. On the other hand, the difference that is less than the threshold value means that the participant has performed substantially no power trading or has performed no power trading during the period of time from the calculation of the previous degree of achievement to the calculation of the current degree of achievement. Therefore, market server 300 decreases the evaluation point of such a participant.

Next, the second update condition will be described. The second update condition includes a condition that the power trading has started or a condition that the power trading has ended. When the second update condition is satisfied, if the content of the trading data satisfies an appropriateness condition, market server 300 increases, by a predetermined amount (for example, one point), the evaluation point corresponding to the trading data. On the other hand, when the second update condition is satisfied, if the content of the trading data does not satisfy the appropriateness condition, market server 300 decreases, by a specific amount (for example, one point), the evaluation point corresponding to the trading data.

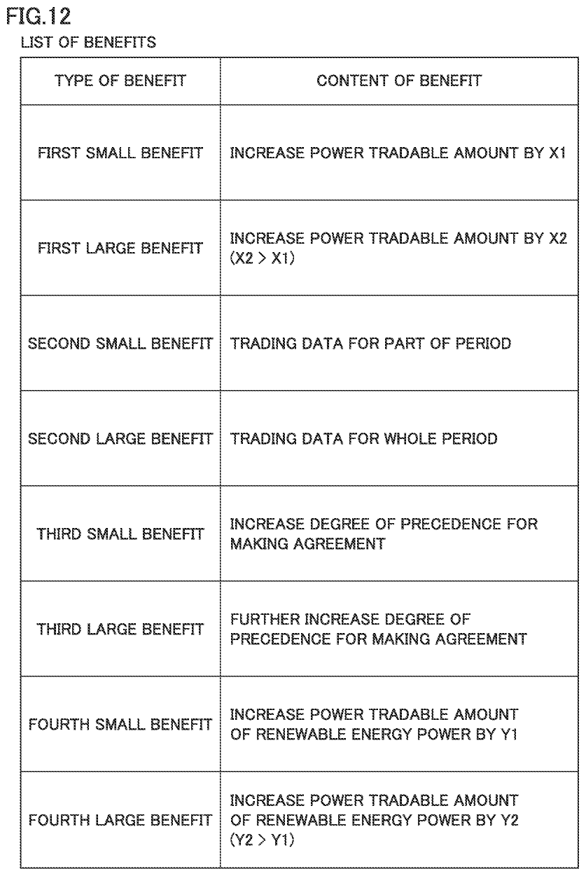

FIG. 11 is a diagram for illustrating the appropriateness condition. In the example of FIG. 11, the appropriateness condition includes a first appropriateness condition, a second appropriateness condition, a third appropriateness condition, and a fourth appropriateness condition.

The first appropriateness condition includes a condition that the power trading price included in the trading data (the power price input to input screen 350 in FIG. 5) falls within a first normal range. The first normal range is a predetermined range. The first normal range may be determined in market server 300 by a predetermined algorithm. The first normal range may be manually determined by an administrator or the like of market server 300.

When a power buyer inputs an extremely high power trading price (i.e., the power trading price exceeds the first normal range), such a problem arises that the power buyer buys up the power in the power trading market, for example. Therefore, market server 300 preferably decreases the evaluation point of such a power buyer.

Further, when a power buyer inputs an extremely low power trading price (i.e., the power trading price falls below the first normal range), such a problem may arise that the power price in the power trading market becomes extremely low), for example. Therefore, market server 300 preferably decreases the evaluation point of such a power buyer.

Further, when a power seller inputs an extremely high power trading price (i.e., when the power trading price exceeds the first normal range), such a problem may arise that the power price in the power trading market becomes extremely high, for example. Therefore, market server 300 preferably decreases the evaluation point of such a power seller.

Further, when a power seller inputs an extremely low power trading price (i.e., the power trading price falls below the first normal range), such a problem arises that a power buyer buys up the power in the power trading market, for example. Therefore, market server 300 preferably decreases the evaluation point of such a power seller.

On the other hand, when a power trading price input by a power buyer or a power seller falls within the first normal range, the above-described problems are unlikely to occur, with the result that power trading is performed smoothly. Therefore, market server 300 preferably increases the evaluation point of such a power buyer or power seller.

The second appropriateness condition includes a condition that the power trading amount included in the trading data (the power trading amount input to input screen 350 in FIG. 5) falls within a second normal range. The second normal range is a predetermined range. The second normal range may be determined in market server 300 by a predetermined algorithm. The second normal range may be manually determined by an administrator or the like of market server 300.

When a power buyer inputs an extremely large power trading amount (i.e., the power trading amount exceeds the second normal range), such a problem may arises that the power buyer buys up the power in the power trading market, for example. Therefore, market server 300 preferably decreases the evaluation point of such a power buyer.

Further, when a power buyer inputs an extremely small power trading amount (i.e., the power trading amount falls below the second normal range), such a problem may arises that confusion of power trading in the power trading market is caused. Therefore, market server 300 preferably decreases the evaluation point of such a power buyer.

Further, when a power seller inputs an extremely large power trading amount (i.e., the power trading amount exceeds the second normal range), such a problem may arises that a power buyer buys up the power in the power trading market, for example. Therefore, market server 300 preferably decreases the evaluation point of such a power seller.

Further, when a power seller inputs an extremely small power trading amount (i.e., the power trading amount falls below the second normal range), such a problem may arise that confusion of power trading in the power trading market is caused, for example. Therefore, market server 300 preferably decreases the evaluation point of such a power seller.

On the other hand, when a power trading amount input by a power buyer or power seller falls within the second normal range, the above-described problems are unlikely to occur, with the result that power trading is performed smoothly. Therefore, market server 300 preferably increases the evaluation point of such a power buyer or power seller.

Next, the third appropriateness condition will be described. As shown in an input item 358 “POWER TYPE” in FIG. 5, the power seller inputs whether or not power to be sold is renewable energy power. Here, since the information input to input item 358 is information indicating a method of generating the power, the information corresponds to “generation information” of the present disclosure. The third appropriateness condition is a condition that market server 300 obtains information indicating that this generation information is accurate.

A malicious power seller may practice deception by check-marking option 360 for renewable energy power so as to sell power even though the power is not actually renewable energy power. Preferably, market server 300 decreases the evaluation point of such a power seller who practices deception. On the other hand, when a power seller check-marks option 360 for renewable energy power and sells renewable energy power, it is preferable to increase the evaluation point of the power seller because the power seller contributes to global environment protection.

A method of determining whether or not the generation information is accurate includes, for example, a method in which an administrator or the like of market server 300 examines a power device of a power seller who has sold power with a renewable label being attached thereto.

When it is determined that the generation information is accurate as a result of examining power device 451, the administrator uses an input device (not shown) to input, to market server 300, accuracy information indicating that the generation information is accurate. In this case, market server 300 obtains the accuracy information. When the accuracy information is obtained, the evaluation point of the power seller is increased because the third appropriateness condition for the trading data is satisfied.

On the other hand, when it is determined that the generation information is inaccurate (i.e., the power seller has practiced deception) as a result of examining power device 451, the administrator uses the input device to input, to market server 300, inaccuracy information indicating that the generation information is inaccurate. In this case, market server 300 obtains the inaccuracy information. When the inaccuracy information is obtained, the evaluation point of the power seller is decreased because the third appropriateness condition for the trading data is not satisfied.

Further, whether or not the power is renewable energy power may be determined by analyzing, by market server 300, the power from power device 451 of the power seller.

Next, the fourth appropriateness condition will be described. As shown in input item 364 “POWER TRADING AMOUNT” and input regions 370, 372 for “TRADING TIME PERIOD” in FIG. 5, each of the participants (power sellers and power buyers) inputs a power trading amount and a trading time period. Further, there is a participant who does not perform power trading as indicated by input power trading amount and trading time period. For example, in some cases, even though a participant inputs a power trading amount and a trading time period, the participant does not perform power trading. In this case, not only a counterpart participant with respect to the participant receives damage but also smooth power trading cannot be realized in the power trading market.

Therefore, market server 300 decreases the evaluation point of the participant who does not perform the power trading as indicated by the input power trading amount and the trading time period. On the other hand, market server 300 increases the evaluation point of the participant who has performed the power trading as indicated by the input power trading amount and the trading time period.

Next, the following describes a method of determining, by market server 300, whether or not a participant has performed power trading as indicated by the input power trading amount and the trading time period.

Although not particularly shown in the figures, power device 451 has an exchange information obtaining unit. The exchange information obtaining unit obtains exchange information and transmits the exchange information to market server 300.

When the participant (power seller) sells power, that is, when power device 451 outputs power, the exchange information includes a time period during which the power is output (i.e., trading time period) and an amount of the power (i.e., power trading amount). Power device 451 transmits the participant ID of the participant (power seller) having power device 451 and the exchange information to market server 300. Market server 300 receives the participant ID and the exchange information.

Market server 300 determines whether or not the time period and the amount of power indicated by the exchange information corresponding to the received participant ID coincide with the trading time period and the power trading amount indicated by the past trading history corresponding to the participant ID. When it is determined that they coincide with each other, the evaluation point of the power seller is increased because the trading data satisfies the fourth appropriateness condition. On the other hand, when it is determined that they do not coincide with each other, the evaluation point of the power seller is decreased because the trading data does not satisfy the fourth appropriateness condition.

When the participant (power buyer) buys power, that is, when power is input to power device 451, the exchange information includes a time period during, which the power is input (i.e., trading time period) and an amount of the power (i.e., power trading amount). Power device 451 transmits the participant ID of the participant (power buyer) having power device 451 and the exchange information to market server 300. Market server 300 receives the participant ID and the exchange information.

Market server 300 determines whether or not the time period and the amount of power indicated by the exchange information corresponding to the received participant ID coincide with the trading time period and the power trading amount indicated by the trading history corresponding to the participant ID. When it is determined that they coincide with each other, the evaluation point of the power buyer is increased because the trading data satisfies the fourth appropriateness condition. On the other hand, when it is determined that they do not coincide with each other, the evaluation point of the power buyer is decreased because the trading data does not satisfy the fourth appropriateness condition.

Regarding the expression “the time period and the amount of power indicated by the exchange information corresponding to the received participant ID coincide with the trading time period and the power trading amount indicated by the trading history corresponding to the participant ID”, they may not completely coincide with each other or may substantially coincide with each other. Here, the expression “the time period indicated by the exchange information corresponding to the received participant ID substantially coincides with the trading time period indicated by the trading history corresponding to the participant ID” means that even when there is a difference between the time period and the trading time period, the difference does not affect the power trading in the power trading market. Further, the expression “the amount of power indicated by the exchange information corresponding to the received participant ID substantially coincides with the power trading amount indicated by the trading history corresponding to the participant ID” means that even when there is a difference between the amount of power and the power trading amount, the difference does not affect the power trading in the power trading market. These differences are adjusted by, for example, the administrator or the like of market server 300.

In the conventional power trading system, a malicious participant may participate in the power trading market. For example, a power buyer as a malicious participant may buy up power by buying the power at a high price. In this case, confusion or the like may be caused in the power trading market. Thus, the power trading market can be provided without guaranteeing reliability of the participant, disadvantageously.

To address this, in the present embodiment, as shown in FIG. 7, market server 300 stores: the participant ID; and the evaluation point set based on the trading history of the participant corresponding to the participant ID. As shown in FIG. 9, when the evaluation point is more than or equal to the first threshold, market server 300 permits the participant specified by the participant ID associated with the evaluation point to participate in the power trading market. Therefore, according to the present embodiment, there can be provided a power trading market in which reliability of a participant is guaranteed.

Further, as shown in FIG. 10, market server 300 increases or decreases the evaluation point based on the trading history of the participant specified by the participant ID associated with the evaluation point. Thus, power trading system 1000 can promote the participant to perform power trading in the power trading market.

Further, as shown in the formula of the degree of achievement in FIG. 10, the trading history of the participant includes the power trading amount (real number A) of the power traded by the participant and the power trading time (real number B) of the power traded by the participant. Thus, power trading system 1000 can promote the participant to increase the power trading amount and the power trading time.

The trading history of the participant includes the power trading price (real number C) of the power traded by the participant and the ratio (real number D) of the renewable energy power in the whole of the power. Thus, power trading system 1000 can promote the participant to increase the renewable energy power and the power trading price.

Market server 300 increases the evaluation point when the content of the trading data satisfies the appropriateness condition, and decreases the evaluation point when the content of the trading data does not satisfy the appropriateness condition (see FIG. 11). Thus, power trading system 1000 can promote the participant to cause the content of the trading data to satisfy the appropriateness condition.

Further, as shown in FIG. 11, the appropriateness condition includes the first appropriateness condition that the power trading price included in the trading data falls within the first normal range. Thus, power trading system 1000 can promote the participant to cause the power trading price to fall within the first normal range.

Further, as shown in FIG. 11, the appropriateness condition includes the second appropriateness condition that the power trading amount included in the trading data falls within the second normal range. Thus, power trading system 1000 can promote the participant to cause the power trading price to fall within the second normal range.

Further, as shown in FIG. 11, the appropriateness condition includes the third appropriateness condition that the information indicating that the generation information indicating the method of generating the power to he sold is accurate is obtained. Thus, power trading system 1000 can promote the participant to accurately indicate the method of generating the power to be sold.

Further, the trading data. includes the power trading time period and the power trading amount. As shown in FIG. 11, the appropriateness condition includes the fourth appropriateness condition that the participant has traded the power corresponding to the power trading amount in the power trading time period. Thus, power trading system 1000 may promote the participant to perform the power trading for the intended power trading amount in the intended power trading time period.

### Benefits

Next, the benefits (large benefit and small benefit) shown in FIG. 9 will be described. FIG. 12 is a diagram showing a list of the benefits in the present embodiment. The benefits include a first benefit, a second benefit, a third benefit, and a fourth benefit. Further, the first benefit includes a first small benefit and a first large benefit. The second benefit includes a second small benefit and a second large benefit. The third benefit includes a third small benefit and a third large benefit. The fourth benefit includes a fourth small benefit and a fourth large benefit.

The first benefit is a benefit that a power tradable amount is increased as compared with a case where no first benefit is provided. The power tradable amount is an amount of power that can be traded (amount of power that can be bought or sold in one trade). The first small benefit is a benefit that the power tradable amount is increased by X1 as compared with the case where no first small benefit is provided. Further, the first large benefit is a benefit that the power tradable amount is increased by X2 as compared with the case where no first large benefit is provided. It should be noted that X2 is larger than X1.

Thus, as the evaluation point is higher, the amount of power (power tradable amount) that can be traded by the participant associated with the evaluation point is increased. Accordingly, power trading system 1000 increases the power trading amount of the participant who has the increased evaluation point, thereby realizing power trading advantageous to the participant.

The second benefit is a benefit that agent device 100 can access power trading data that cannot be accessed when no second benefit is provided. Agent device 100 can display a power trading screen on display device 104 of agent device 100 by accessing such power trading data.

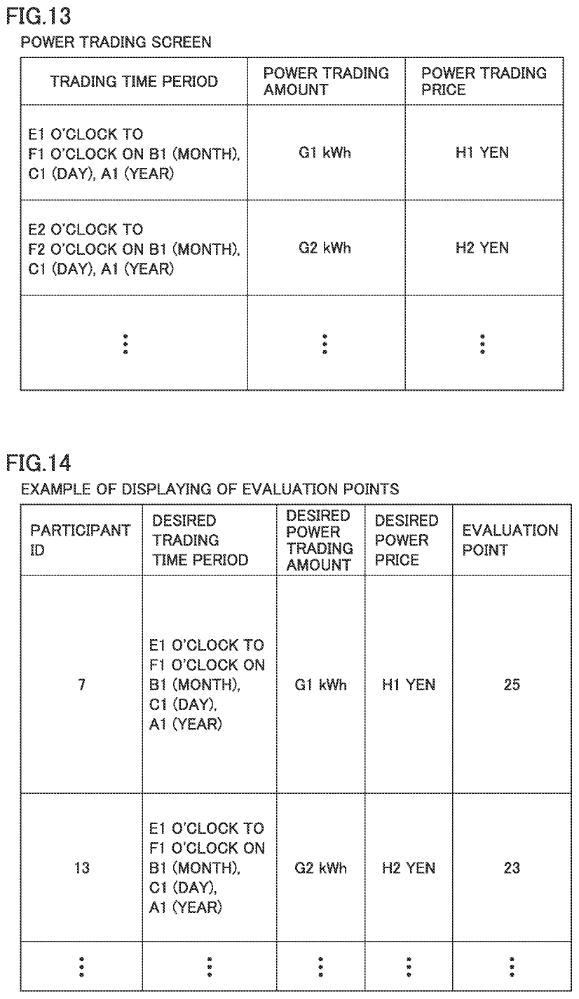

FIG. 13 shows an exemplary power trading screen. As the power trading screen of FIG. 13, trading information (trading time period, power trading amount, and power trading price) on the trading by the user and other participant(s) is displayed. In the example of FIG. 13, it is illustratively shown that the trading time period ranges from E1 o'clock to F1 o'clock on B1 (month), C1 (day), A1 (year), the power trading amount is G1 kWh, and the power trading price is H1 yen. Although only part of the trading information is displayed in the example of FIG. 13, a larger number of pieces of the trading information are actually displayed.

By visually recognizing the trading information, the participant can check in which time period advantageous trading can be performed, for example. The advantageous trading is to sell power at a high price when the participant is a power seller, and is to buys power at a low price when the participant is a power buyer. Further, in the example of FIG. 13, information that specifies the other participant(s) is not displayed in view of privacy protection.

In the present embodiment, the second small benefit is a benefit that allows for access to power trading data by which a power trading screen for a predetermined past period (for example, one month) can be displayed. On the other hand, the second large benefit is a benefit that allows for access to power trading data by which a power trading screen for a whole period can be displayed.

In the present embodiment, it has been described that a difference between the second large benefit and the second small benefit is a difference in period for the trading information. As a modification, the difference may be a difference in type of information in the trading information.

Thus, as the evaluation point is higher, the power trading data accessible by agent device 100 is increased. Accordingly, power trading system 1000 allows the participant who has an increased evaluation point to visually recognize a larger number of pieces of the trading information, thereby realizing power trading advantageous to the participant.

The third benefit is a benefit that market server 300 gives precedence for making an agreement on the power trading as compared with a case where no third benefit is provided. Further, when such a third benefit is employed, market server 300 has an authority to make an agreement between participants.

The third small benefit is a benefit that a degree of precedence for making an agreement is increased. Further, the third large benefit is a benefit that the degree of precedence for making an agreement is more increased. For example, when the bidding condition of a power buyer provided with the third small benefit is the same or substantially the same as the bidding condition of a power buyer provided with no third small benefit, market server 300 gives precedence for making agreement on the bidding of the power buyer provided with the third small benefit. Further, when the bidding condition of a power buyer provided with the third large benefit is the same or substantially the same as the bidding condition of a power buyer provided with no third large benefit (power buyer provided with the third small benefit or power buyer provided with no third small benefit), market server 300 gives precedence for making an agreement on the bidding of the power buyer provided with the third large benefit.

The fourth benefit is a benefit that the power tradable amount of renewable energy power is increased as compared with a case where no fourth benefit is provided. The fourth small benefit is a benefit that the power tradable amount of renewable energy power is increased by Y1 as compared with the case where no fourth small benefit is provided. Further, the fourth large benefit is a benefit that the power tradable amount of renewable energy power is increased by Y2 as compared with the case where no fourth benefit is provided. It should be noted that Y2 is larger than Y1.

A power seller having a high evaluation point is quite unlikely to practice such deception that the power to be sold as renewable energy power is a different type of power. Therefore, as the evaluation point of the power seller is increased, an amount of renewable energy power that can be said by the power seller is increased. Thus, a power buyer can buy renewable energy power from the power seller with a sense of security.

An amount of generation of renewable energy power may be varied depending on a time period. When the renewable energy power is generated by, for example, photovoltaic power generation, the amount of generation of the renewable energy power differs depending on a duration of sunshine. Therefore, in consideration of a time period during which the renewable energy power is generated, the power seller may make a plan for a time period during which the renewable energy power is sold.

If an amount of renewable energy power bought by a power buyer having a low evaluation point is large, trading for the renewable energy power may not be performed in the power trading time period included in the request condition of the power buyer. In this case, even though the power seller has made a plan for a time period during which the renewable energy power is sold, the power seller may become unable to sell the power during the time period during which the renewable energy power is sold, with the result that the power seller may receive damage. To address this, in the present embodiment, when the evaluation point of the power buyer is increased, an amount of renewable energy power that can be bought by the power buyer is increased. In other words, when the evaluation point of the power buyer is low, the amount of renewable energy power that can be bought by the power buyer becomes low. Accordingly, power trading system 1000 can realize smooth power trading without causing the above-described damage to the power seller.

Further, a program by which market server 300 can perform the process described with reference to FIGS. 9 to 12 is stored in storage unit 306 (for example, ROM 76).

In the present embodiment, it has been described that as shown in FIG. 9, the first small benefit, the second small benefit, the third small benefit, and the fourth small benefit are provided based on the same second threshold (the second threshold is 10 points in each case). However, at least two of the first small benefit, the second small benefit, the third small benefit, and the fourth small benefit may be provided based on different second thresholds.

In the present embodiment, it has been described that as shown in FIG. 9, the first large benefit, the second large benefit, the third large benefit, and the fourth large benefit are provided based on the same third threshold (the third threshold is 20 points in each case). However, at least two of the first large benefit, the second large benefit, the third large benefit, and the fourth large benefit may be provided based on different third thresholds. Further, a benefit different from the first benefit to the fourth benefit may be employed.

### Displaying of Points

As described with reference to FIG. 7, market server 300 can display the evaluation point. For example, when a power buyer inputs a request condition to an agent device 100, if there are a plurality of bidders for the request condition, agent device 100 may display the respective evaluation points of the plurality of bidders. FIG. 14 shows an example of displaying of the evaluation points.

In the example of FIG. 14, a participant ID 7 is associated with a desired trading time period, a desired power trading amount, and a desired power price, and is also associated with an indication that the evaluation point is 25. The presenter (power buyer or power seller) can select a bidder (for example, a bidder having a high evaluation point) from the screen with reference to the evaluation points. Accordingly, the presenter can recognize the evaluation points, thus resulting in reliable power trading. Further, the participant can visually recognize the evaluation point displayed on his/her agent device 100.

### Flowchart

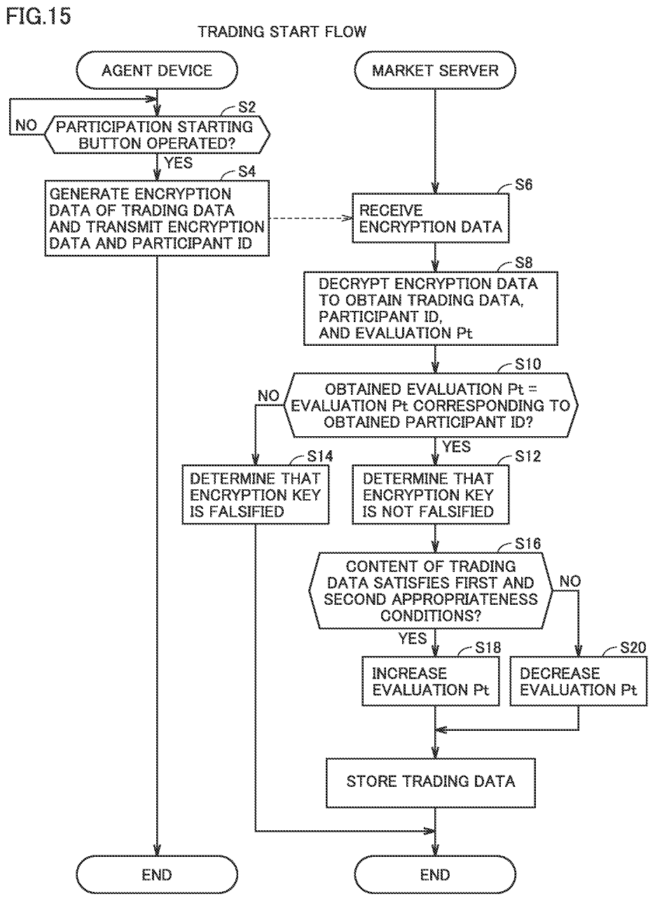

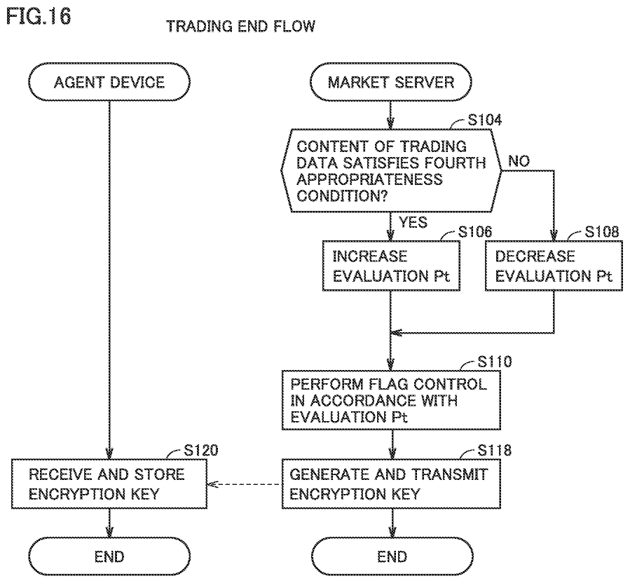

FIGS. 15 and 16 are flowcharts showing processes of agent device 100 and market server 300 in the present embodiment. FIG. 15 shows a trading start flow, which is started when agent device 100 displays the input screen (see FIG. 5).

In a step S2, agent device 100 determines whether or not participation starting button 378 (see FIG. 5) has been operated. Agent device 100 repeats the process of step S2 until YES is determined in step S2. When YES is determined in step S2, the process proceeds to a step S4.

In step S4, agent device 100 generates encryption data by encrypting the trading data using encryption key 1121. Then, agent device 100 transmits the input participant ID and the encryption data to market server 300.

In a step S6, market server 300 receives the encryption data. Then, in a step S8, market server 300 decrypts the encryption data, thereby obtaining the trading data, the participant ID, and the evaluation point.

Next, in a step S10, market server 300 determines whether or not the evaluation point associated with the obtained participant ID coincides with the obtained evaluation point. When both the evaluation points do not coincide with each other (NO in step S10), market server 300 determines in a step S14 that the encryption key is falsified. Thereafter, market server 300 transmits, to agent device 100, a notification indicating that the encryption key is falsified, and ends the process of FIG. 15.

On the other hand, when both the evaluation points coincide with each other (YES in step S10), market server 300 determines in a step S12 that the encryption key is not falsified. Next, in a step S16, it is determined whether or not the content of the trading data decrypted in step S8 satisfies the first appropriateness condition and the second appropriateness condition. When the content of the trading data does not satisfy at least one of the first appropriateness condition and the second appropriateness condition, market server 300 decreases the evaluation point in a step S20.

On the other hand, when the content of the trading data satisfies both the first appropriateness condition and the second appropriateness condition, market server 300 increases the evaluation point in a step S18. After step S18 or step S20, market server 300 stores the trading data and ends the trading start flow.

FIG. 16 shows a trading end flow, which is performed by market server 300 when the ending time of the power trading time period of the trading for which an agreement is made is reached. In a step S104, market server 300 determines whether or not the content of the trading data satisfies the fourth appropriateness condition. When the content of the trading data does not satisfy the fourth appropriateness condition (NO in step S104), market server 300 decreases the evaluation point in step S108. On the other hand, when the content of the trading data satisfies the fourth appropriateness condition (YES in step S104), market server 300 increases the evaluation point in step S106.

In step S110, market server 300 performs flag control in accordance with the evaluation point. In step S110, when the evaluation point is more than or equal to the second threshold, market server 300 provides a small benefit (associates the small-benefit flag in FIG. 7). Further, in step S110, when the evaluation point is more than or equal to the third threshold, market server 300 provides a large benefit (associates the large-benefit flag in FIG. 7). Further, in step S110, when the evaluation point is less than the first threshold, market server 300 prohibits access to the power trading market (associates the non-permission flag in FIG. 7).

Next, market server 300 generates an encryption key associated with the evaluation point, and transmits the encryption key to agent device 100. Next, in step S120, when agent device 100 receives the encryption key, agent device 100 stores the encryption key as encryption key 1121 in storage unit 112 (see FIG. 8).

### Modifications

In the above embodiment, it has been described that the participant evaluation information is the evaluation point. However, the participant evaluation information may be other information. For example, the participant evaluation information may be a participant rank. For example, the participant rank is constituted of five stages, i.e., is constituted of a first rank, a second rank, a third rank, a fourth rank, and a fifth rank.

For example, the first rank is a rank with which access to the power trading market by agent device 100 is prohibited. The second rank is a rank with which access to the power trading market by agent device 100 is permitted. The third rank is a rank with which the above-described small benefit is provided. The fourth rank is a rank with which the above-described benefit is provided. The fifth rank is a rank with which a benefit larger than the large benefit is provided.

The initial rank of the participant ranks is the second rank. When the first update condition or the second update condition is satisfied, market server 300 updates the participant rank. For example, when the condition for increasing the evaluation point is satisfied one or more times, market server 300 raises the participant rank to a higher rank. Further, for example, when the condition for decreasing the evaluation point is satisfied one or more times, market server 300 lowers the participant rank to a lower rank.

The first rank is referred to as, for example, “blacklist member”. The second rank is referred to as, for example, “regular member”. The third rank is referred to as, for example, “silver member”. The fourth rank is referred to as, for example, “gold member”. The fifth rank is referred to as, for example, “platinum member”.

Although the embodiments of the present invention have been described and illustrated in detail, it is clearly understood that the same is by way of illustration and example only and is not to be taken by way of limitation, the scope of the present invention being interpreted by the terms of the appended claims.

What is claimed is:

1. A market server comprising:
a memory that stores participant information of each of participants in a power trading market; and
a processor, wherein
the participant information includes
a participant ID that specifies the participant, and
participant evaluation information associated with the participant ID and set based on a trading history of the participant, and
when the participant evaluation information satisfies a predetermined condition, the processor permits the participant specified by the participant ID associated with the participant evaluation information to participate in the power trading market.

2. The market server according to claim 1, wherein
the participant evaluation information is an evaluation point, and
the participant evaluation information satisfies the predetermined condition when the evaluation point is more than or equal to a first threshold.

3. The market server according to claim 2, wherein the processor increases or decreases the evaluation point based on the trading history of the participant specified by the participant ID associated with the evaluation point.

4. The market server according to claim 3, wherein
the trading history of the participant includes at least one of
a power trading amount of power traded by the participant, and
a power trading time of the power traded by the participant.

5. The market server according to claim 3, wherein
power traded in the power trading market includes
first power involving a first amount of carbon dioxide to be discharged to generate a unit amount of power, and
second power involving a second amount of carbon dioxide to be discharged to generate the unit amount of power, the second amount being less than the first amount, and
the trading history of the participant includes at least one of
a ratio of the second power in power traded by the participant, and
a power trading price of the power traded by the participant.

6. The market server according to claim 2, wherein
the processor obtains the participant ID and trading data about power trading,
when a content of the trading data satisfies an appropriateness condition, the processor increases the evaluation point associated with the participant ID, and
when the content of the trading data does not satisfy the appropriateness condition, the processor decreases the evaluation point associated with the participant ID.

7. The market server according to claim 6, wherein the appropriateness condition includes a condition that a power trading price included in the trading data falls within a first normal range.

8. The market server according to claim 6, wherein the appropriateness condition includes a condition that a power trading amount included in the trading data falls within a second normal range.

9. The market server according to claim 6, wherein
the trading data includes generation information indicating a method of generating power to be sold, and
the appropriateness condition includes a condition that the market server obtains information indicating that the generation information is accurate.

10. The market server according to claim 6, wherein
the trading data includes a power trading time period and a power trading amount, and
the appropriateness condition includes a condition that power corresponding to the power trading amount has been traded by the participant during the power trading time period.

11. The market server according to claim 2, wherein the processor outputs an evaluation point of a participant who makes a bid for a request condition, to at least one of an agent device used by a participant who has presented the request condition and an agent device used by the participant who makes the bid.

12. The market server according to claim 2, wherein the processor updates the participant information to provide the participant with a larger benefit as the evaluation point is higher.

13. The market server according to claim 12, wherein the larger benefit includes an increase in power trading amount.

14. The market server according to claim 12, wherein the larger benefit includes an increase in power trading data accessible by an agent device used by the participant.

15. The market server according to claim 12, wherein the larger benefit includes an increase in degree of precedence for making an agreement on the power trading.

16. The market server according to claim 12, wherein
power traded in the power trading market includes
first power involving a first amount of carbon dioxide to be discharged to generate a unit amount of power, and
second power involving a second amount of carbon dioxide to be discharged to generate the unit amount of power, the second amount being less than the first amount, and
the larger benefit includes an increase in trading amount of the second power.

17. The market server according to claim 2, wherein
the market server transmits, to an agent device used by the participant, an encryption key corresponding to the evaluation point associated with the participant ID,
the agent device generates encryption data by encrypting, using the encryption key, trading data about participation in the power trading market,
the agent device transmits the participant ID and the encryption data to the market server,
the market server obtains the trading data, the participant ID, and the evaluation point by decrypting the encryption data using a decryption key corresponding to the encryption key, and
when the evaluation point associated with the obtained participant ID coincides with the obtained evaluation point, the market server determines that the encryption key is not falsified.

18. A power trading system comprising:
a market server of a power trading market; and
an agent device used by each of participants of the power trading market, wherein
the market server has a memory that stores participant information of the participant,
the participant information includes
a participant ID that specifies the participant, and
participant evaluation information associated with the participant ID and set based on a trading history of the participant, and
when the participant evaluation information satisfies a predetermined condition, the market server permits the participant specified by the participant ID associated with the participant evaluation information to participate in the power trading market.
